(19) United States
(12) Patent Application Publication
(10) Pub. No.: US 2023/0166959 A1
(43) Pub. Date: Jun. 1, 2023

(54) METHOD AND APPARATUS FOR DISPENSING A SUPERCOOLED BEVERAGE

(71) Applicant: Heineken Supply Chain B.V., Amsterdam (NL)

(72) Inventor: Petrus Johannes VAN GEIJLSWIJK, Voorschoten (NL)

(21) Appl. No.: 17/919,121

(22) PCT Filed: Apr. 16, 2021
(86) PCT No.: PCT/NL2021/050244

§ 371 Date: Oct. 14, 2022

(30) Foreign Application Priority Data
Apr. 17, 2020 (NL) 2025364

(51) Int. Cl. B67D 1/08

(52) U.S. Cl. CPC B67D 1/0858; B67D 1/0884; B67D 1/0885

(57) ABSTRACT

A method and device are provided for dispensing a beverage. The method comprises cooling a beverage to a first temperature below a melting point of the beverage, receiving a beverage container with a storage volume for receiving the beverage, pressurising the storage volume of the beverage container up to a first pressure, dispensing the beverage into the pressurised storage volume of the beverage container, and decreasing the pressure in the storage volume of the beverage container to ambient pressure, wherein the beverage is cooled to a first temperature below a melting point of the beverage prior to decreasing the pressure in the storage volume of the beverage container to ambient pressure. The device may be arranged to perform parts of the method.

### FIELD OF THE INVENTION

The invention relates to the field of dispensing supercooled beverages.

### BACKGROUND

EP2207459B 1discloses a system and method for dispensing iced beer. The beer is supplied to and cooled in a heat exchanger where it becomes supercooled. The beverage exits the heat exchanger and immediately passes through an orifice section of reduced diameter and subsequently into a pipe of increased diameter relative to the orifice thereby creating a Venturi effect, causing the production of ice seeds in the beer prior to the beer being dispensed. The beer with the ice seeds can then be dispensed into a beverage container.

### SUMMARY

It is preferred to provide a method and beverage dispensing assembly for dispensing a beverage, which allow convenient dispensing of a beverage into a beverage container. The beverage is preferably consumed as a supercooled beverage, and hence, it is preferred to provide the method and beverage dispensing assembly such that a supercooled beverage may be provided to a consumer. A supercooled beverage may be defined as a beverage with a temperature lower than its melting point, while the beverage is still in the fluid phase. After being exposed to the proper conditions, the person skilled in the art will appreciate that the fluid supercooled beverage may become at least partially solidified, to for example resemble a slush drink.

A beverage may be a mixture of different components, for example a solution of different components in water. A particular beverage may not have an exactly defined freezing point, but may instead exhibit solidification over a particular range of temperatures. The freezing point or freezing range of the beverage may correspond to the melting point of the beverage. The melting point of the beverage may be defined as the temperature at which, under ambient pressure, solidified beverage or solidified particles in the beverage disappear instead of are formed. Hence, the melting point of a substance is the temperature at which it changes state from solid to fully liquid.

The person skilled in the art will understand that the ambient pressure is, among others, dependent on the altitude and weather and climate conditions. Hence, the exact melting point in a particular situation may depend on the altitude and weather and climate conditions at which the beverage is present.

A first aspect provides a method of dispensing a beverage, comprising cooling a beverage to a first temperature below a melting point of the beverage, receiving a beverage container with a storage volume for receiving the beverage, pressurising the storage volume of the beverage container up to a first pressure, dispensing the beverage into the pressurised storage volume of the beverage container, and decreasing the pressure in the storage volume of the beverage container to ambient pressure, wherein the beverage is cooled to a first temperature below a melting point of the beverage prior to decreasing the pressure in the storage volume of the beverage container to ambient pressure.

By dispensing the beverage into a pressurised storage volume of the beverage container, it may be at least substantially prevented that ice crystals already occur in the dispensing line. These ice crystals may impair flow of the beverage, and/or make it more difficult to control the flow of beverage and may hence be undesired.

While dispensing the beverage, the pressure in the storage volume of the beverage container may be decreased from the first pressure to a second pressure. In further examples, the pressure in the storage volume of the beverage container may be decreased again from the second pressure to a further pressure. In even further examples, the pressure may be decreased in any number of steps, for example in two, three, four, five, six, or even more steps. In general, decreasing the pressure in the storage volume of the beverage container may be substantially stepwise, gradually, in any other way, or in any combination thereof.

Preferably, before and during the dispensing thereof, the beverage is substantially in a fluid state, and also preferably in a supercooled state. In the fluid state of the beverage, the beverage may flow easier than in the solidified state. Hence, dispensing of the beverage substantially in the fluid state may be preferred.

When the pressure in the storage volume of the beverage container drops substantially stepwise, a pressure shock may occur which may create ice seeds in the supercooled beverage present in the storage volume of the beverage container.

In embodiments, the shock to create ice seeds in the supercooled beverage present in the storage volume of the beverage container may be created using at least one of a pressure drop, ultrasound waves, vibrations, a physical impact to the beverage container, or any combination thereof.

In particular embodiments, the beverage may be dispensed into the pressurised storage volume while the beverage is at the first temperature. Hence, the beverage may be cooled to the first temperature prior to entering the storage volume. As a further option, the beverage may be cooled to the first temperature after being dispensed into the pressurised storage volume of the beverage container.

The beverage container has a certain temperature and thermal capacity when the beverage is dispensed into its storage volume, which temperature and thermal capacity are indicative of the thermal energy stored in the beverage container. If the thermal energy comprised by the beverage container is too high, this thermal energy when at least partially transferred to the dispensed beverage may negatively impact the dispensing process. Due to this negative impact, the desired supercooling of the beverage may not be achieved.

In embodiments, a beverage container with a low thermal capacity and/or a low thermal conductivity may be used to at least partially prevent the beverage container from heating the beverage inside the storage volume. As such, the beverage container may be a double-walled container which may for example comprise a hollow chamber, which chamber may be at a vacuum. The mass of the beverage container may be kept as low as possible, for example by manufacturing the beverage container as a thin-walled beverage container. Furthermore, the beverage container may be made from one or more materials with a low thermal capacity and/or thermal conductivity.

As an option, the beverage container may be cooled down before the beverage is dispensed into its storage volume. For example, the beverage container may be cooled down to the first temperature. This cooling may be performed in a separate cooling device arranged for cooling the beverage container, preferably to or below the first temperature. The beverage container cooling device may also be comprised by embodiments of a beverage dispensing assembly.

During dispensing of the beverage, the beverage may be provided at a third pressure, which third pressure may be higher or substantially equal to the first pressure to which the storage volume of the beverage container is pressurised.

In particular examples, the beverage may comprise alcohol, sugar, a dissolved gas, or any combination thereof. The alcohol by volume content may be 0.5% or more, for example between 1% and 10%. The dissolved gas may for example be carbon dioxide for carbonated beverages, or nitrogen for nitrogen infused beverages.

The sugar content of the beverage may be 2 grams per litre or more, for example 5 grams per litre or more, 15 grams per litre or more or even 25 grams per litre or more. The sugar content may also be expressed in a Brix value of a fluid, which may be determined using a refractometer. One degree Brix is equivalent to 1 gram of sucrose in 100 gram of liquid solution. If the solution contains dissolved solids other than pure sucrose, then the amount of degrees Brix only approximates the dissolved solid content. Hence, the Brix value of the beverage may be 2 degrees or more, 5 degrees or more, between 8 and 12 degrees, 15 degrees or more, or even 25 degrees or more.

Examples of beverages which may be dispensed using the method according to the first aspect are for example beers, for example fruit biers such as kriek style beers, ciders such as for example apple cider or pear cider, soft drinks, coffee, tea, cocktails comprising hard liquor such as rum, vodka, or tequila, any other beverage or any combination thereof.

The method of dispensing a supercooled beverage may further comprise sampling the beverage before dispensing the beverage for obtaining beverage data indicative of at least one of alcohol content, sugar content, and dissolved gas content. In further examples, any other beverage parameter may be sampled, optionally in combination with the alcohol content, sugar content, and dissolved gas content.

The alcohol content, sugar content, and dissolved gas content may affect the melting temperature of the beverage and/or dispensing properties such as the tendency to foam. To be able to obtain a preferred dispensing result, the method may further comprise controlling at least one of the first temperature to which the beverage is cooled, the first pressure and, if used, the second pressure, third pressure, any other optional subsequent pressure, and when to decrease the pressure in the storage volume from the first pressure to the second pressure and to any optional further pressure. The controlling of any of these parameters may be based on the obtained beverage data, or at least part thereof.

By virtue of the method according to the first aspect, the dispensed beverage may comprise solidified beverage at least after the pressure in the storage volume is decreased to the ambient pressure. Hence, the beverage may still be in substantially fluid and supercooled state after being dispensed into the storage volume, and solidification may only commence after the pressure in the storage volume is decreased to the ambient pressure.

A second aspect provides a beverage dispensing assembly for dispensing a supercooled beverage, comprising a cooling unit for cooling a beverage to a first temperature below the melting point of the beverage, a pressurisation unit for pressurizing a storage volume of a beverage container, a dispensing unit for dispensing the beverage into the storage volume of the beverage container, and a pressure control unit for controlling a pressure in the storage volume and arranged to decrease the pressure in the storage volume.

The pressure control unit may be embodied as a valve which may be operable by a user. By selectively closing and at least partially opening the valve, the user may control the pressure in the storage volume. The user may control the pressure for example using visual inspection of the flow of beverage into the beverage container. Optionally, the pressure control unit may comprise an electronic control unit like a microcontroller arranged to control the valve or other electrical, electro-mechanical or mechanical pressure regulator, optionally as a function of time, volume of dispensed beverage, pressure in the beverage container, other, or a combination thereof.

In an embodiment, the pressurisation unit comprises a sealable pressure chamber arranged to receive the beverage container therein. By pressurising the pressure chamber with the beverage container inside, the storage volume of the beverage container is also pressurised. This particular embodiment decreases the requirements of the beverage container, as the beverage container does not need to be strong enough for maintaining the pressure inside as the pressure inside and outside the beverage container is equal inside the pressure chamber of the pressurisation unit.

In an alternative embodiment, the pressurisation unit comprises a sealing mechanism for sealing of the storage volume of the beverage container, wherein the sealing mechanism comprises a gas passage for allowing passage of a pressurised gas into the storage volume. In this embodiment, the beverage container acts as the pressure vessel, wherein the pressure inside the storage volume is higher than the pressure outside the beverage container.

When the pressurisation unit comprises the sealing mechanism, the sealing mechanism may further comprise a beverage passage for allowing passage of the beverage into the storage volume. Alternatively, the beverage container may be provided with a beverage passage for allowing passage of the beverage into the storage volume.

The pressurisation unit may further comprise a sampling unit for sampling the beverage before dispensing for obtaining beverage data indicative of at least one of alcohol content, sugar content, and dissolved gas content.

For controlling the pressurisation unit, the beverage dispensing assembly may further comprise a controller. The controller may be arranged to control at least one of the pressure control unit and the pressurisation unit.

The beverage dispensing assembly may also further comprise a sensor unit for determining dispensing data. The controller may then be arranged for receiving the dispensing data and controlling the pressurisation unit based on the dispensing data.

In embodiments, the controller may be arranged for receiving a user input. The user input may comprise input data related to beverage data indicative of at least one of alcohol content, sugar content, and dissolved gas content. As such, a user may provide relevant information to the controller such that the dispensing process can be controlled to the desired effect of providing a supercooled beverage.

The dispensing data may for example comprise data indicative of a volume of beverage present in the storage volume of the beverage container, such as a fluid level in the storage volume, a volume of beverage dispensed, any other parameter indicative of a volume of beverage present in the storage volume or any combination thereof.

### BRIEF DESCRIPTION OF THE FIGURES

The aspects and embodiments thereof will be elucidated in conjunction with figures. In the figures:

FIG. 1 schematically shows an embodiment of a beverage dispensing assembly for dispensing a supercooled beverage;

FIG. 2 schematically depicts a method of dispensing a supercooled beverage;

FIG. 3 schematically shows another embodiment of a beverage dispensing assembly for dispensing a supercooled beverage; and

FIG. 4 schematically depicts another embodiment of a method of dispensing a supercooled beverage

### DETAILED DESCRIPTION OF THE FIGURES

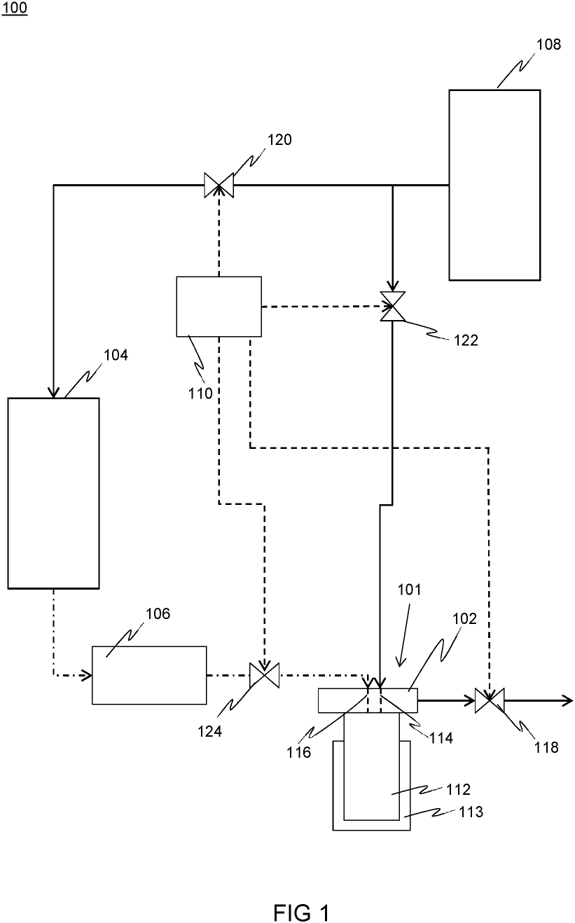

FIG. 1 schematically shows an embodiment of a beverage dispensing assembly 100 for dispensing a supercooled beverage. The assembly 100 comprises a cider cooler 106 as a cooling unit for cooling cider as an example of a beverage to a first temperature below the melting point of the cider. For example, upstream of the cider cooler 106, the cider may be at ambient temperature or at a precooled temperature level. Downstream of the cider cooler 106, the cider is cooled to the first temperature by virtue of the cider cooler 106. Downstream of the cider cooler 106 an optional beverage flow valve 124 is provided to control the flow of beverage from the cider cooler 106.

The embodiment of the beverage dispensing assembly 100 of FIG. 1 further comprises a sealing mechanism 102 comprised by a pressurisation unit 101 for pressurizing a storage volume of a beverage container. A glass 112 is provided as an example of a beverage container, which for example may have a storage volume of 200 ml, 473 mL, 500 mL, 1000 mL, or more than 1000 mL. After filling the glass 112, the glass 112 may be provided to a consumer who may consume the dispensed beverage directly from the glass 112. In other examples the beverage container may be a pitcher, jug, or another type of pouring vessel which can be used to fill a plurality of glasses.

The sealing mechanism 102 is arranged to create a gas-tight seal with the storage volume of the glass 112, such that a pressure chamber is created between the sealing mechanism 102 and the storage volume of the glass 112. To provide a pressurised gas into the pressure chamber, a gas passage 114 is provided through the sealing mechanism 102.

The sealing mechanism 102 further comprises a cider passage 114 as a beverage passage, which allows passage of the cooled cider provided by the cider cooler 106 into the pressure chamber of the glass 112. As such, beverage can be dispensed into the storage volume of the glass 112, also when the sealing mechanism 102 forms a gas tight seal with the glass 112.

The pressurisation unit 101 further comprises as an option a gas drain valve 118 which is in fluid connection with the pressure chamber through the sealing mechanism 102. Using the gas drain valve 118, the volume of gas inside the pressure chamber and thus the pressure inside the pressure chamber may be controlled. The gas drain valve 118 may be actively controllable by a controller, or may be pre-set to a pre-determined pressure level.

As shown in FIG. 1, a keg 104 as an example of a beverage supply container comprising cider as an example of a beverage is provided, and connected to an upstream side of the cider cooler 106. In other examples, the beverage supply container may be a tank, bag-in-container, or any other suitable container vessel for holding a large volume of beverage for filling a plurality of smaller beverage containers with.

Furthermore shown in FIG. 1 is a carbon dioxide canister 108 as an example of a pressurised gas source. In this particular embodiment, as an option, the carbon dioxide canister 108 is the pressurised gas source used for pressurising the cider keg 104 as well as for providing pressurised gas to the pressurisation unit 101.

In particular, a keg pressure valve 120 is provided between the carbon dioxide canister 108 and the cider keg 104. With the keg pressure valve 120, a pressure on the cider inside the keg 104 may be controlled. Furthermore, a pressurisation unit valve 122 is provided between the carbon dioxide canister 108 and the sealing mechanism 102, which pressurisation unit valve 122 is comprised by the pressurisation unit 101. Using the pressurisation unit valve 122, the flow of pressurised gas between the carbon dioxide canister 108 and the sealing mechanism 102 may be controlled.

A controller 110 is further comprised by the beverage dispensing assembly 100 for controlling at least part of a method dispensing a supercooled beverage. In particular embodiments, the controller 110 may be arranged to control at least one of the beverage flow valve 124, keg pressure valve 120, pressurisation unit valve 122 and drain valve 118. When a particular combination of any of these four valves, for example all four, is controllable, a substantially automatic dispensing method may be governed by the controller 110.

As an option which may be applied to any embodiment of the beverage dispensing assembly, the beverage dispensing assembly of FIG. 1 comprises a container cooler unit 113 arranged to cool the beverage container 112. Preferably, the container cooler unit 113 is arranged to cool the beverage container 112 to the first temperature. This implies that an average temperature of the beverage container 112 may lowered to the first temperature by virtue of the container cooler unit 113.

For example, the container cooler unit 113 may be shaped such that at least part of the beverage container 112 may contact the container cooler unit 113, to allow thermal energy to be transferred from the beverage container 112 to the container cooler unit via conduction. Additionally or alternatively, convection and/or radiation may be used for transfer of thermal energy.

As a further option, a beverage dispensing assembly 100 may comprise a temperature sensor unit arranged for obtaining temperature data indicative of a temperature of at least a part of the dispensing container. For example, a contactless temperature probe may be used which infers temperature from a portion of the thermal radiation emitted by the beverage container.

When the controller 110 is arranged to receive this temperature data, the beverage may only be dispensed when the temperature of the beverage container is below a pre-determined threshold, such as the first temperature.

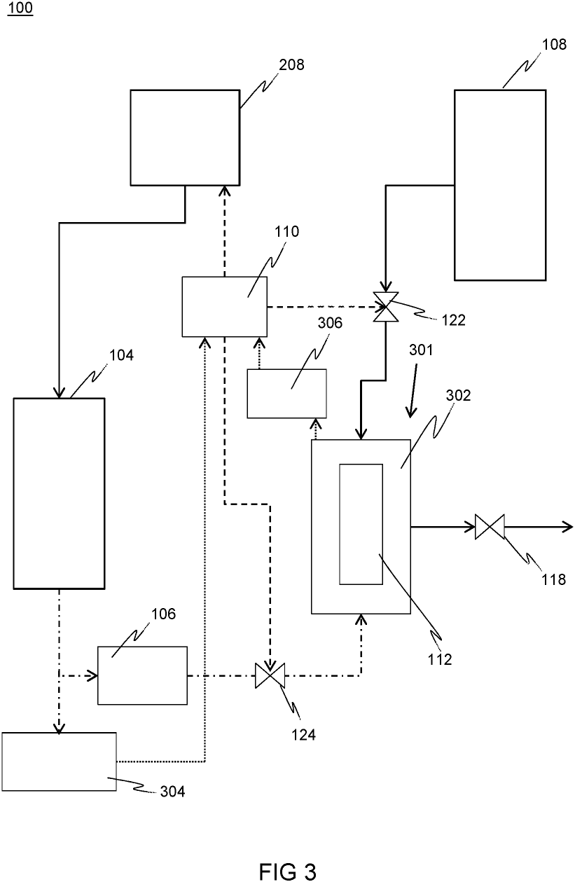

In general, in the schematical FIGS. 1 and 3, dashed lines represent control signals associated with the controller 110, dash-dotted lines represent flows of beverage, solid lines represent flows of gas, and dotted lines represent sensor signals.

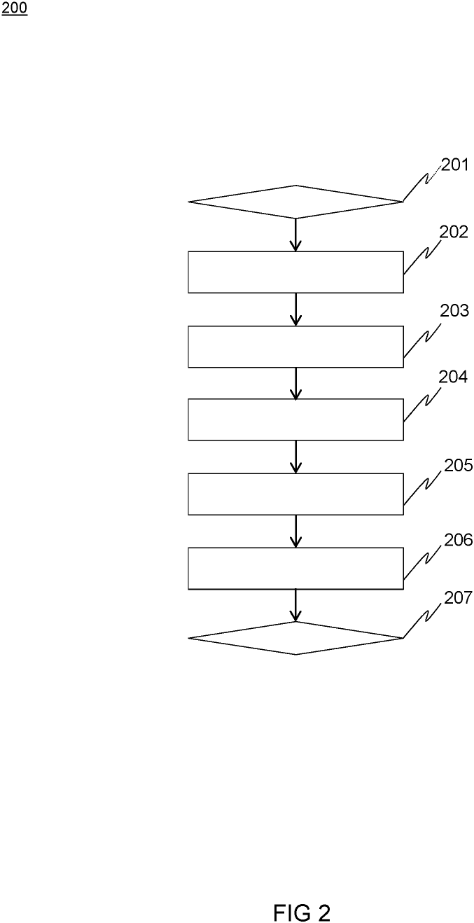

An embodiment of a method 200 for dispensing a supercooled beverage is depicted in FIG. 2, of which at least a part may be governed by the controller 110. The method 200 starts in an initialisation step 201. In practice, for example, a user input to the controller 110 may start the initialisation step 201 of the method 200. At the initialisation step 201, one or more safety checks may be performed by the controller 110 to check whether the assembly 100 is ready for dispensing beverage.

In a second step 202, the cider as an example of a beverage is cooled to a first temperature below a melting point of the beverage. This cooling may be performed by the cider cooler 106. Hence, the controller 110 may as an option also be arranged to control the cider cooler 106. Alternatively, a user may provide a set-point to the cider cooler 106 corresponding to the first temperature such that the cider cooler 106 on its own cools the cider to the first temperature.

In an optional third step 203, particular to the assembly 100 of FIG. 1, a gas-tight seal is created between the sealing mechanism 102 and the beverage container 112. The gas-tight seal may for example be created by moving at least one of the sealing mechanism 102 and the beverage container 112 towards each other to press the one against the other.

In general, the beverage container 112 may be pre-cooled to a temperature below ambient temperature before dispensing beverage into the beverage container 112. Hence, the method 200 may comprise a step of cooling the beverage container 112 to a temperature below ambient temperature, for example to a temperature above, substantially equal to, or lower than the first temperature.

In a fourth step 204 of the method 200, the pressure chamber created by the sealing mechanism 102 and the beverage container 112 is pressurised up to a first pressure. For example, this fourth step 204 may be executed by the controller 110 operating the pressurisation unit valve 122.

In a fifth step 205, the beverage is dispensed into the pressurised storage volume of the beverage container 112. For example, this dispensing of the beverage may be governed by the controller 110 controlling the beverage flow valve 124 and/or the controller 110 operating the keg pressure valve 120.

In a sixth step 206, the pressure in the storage volume of the beverage container 112 is released to ambient pressure, such that the beverage container 112 which is now filled with the supercooled beverage can be removed from the assembly safely. For example, the releasing of the pressure in the storage volume of the beverage container 112 may be governed by the controller 110 operating the gas drain valve 118. The method 200 ends in a terminator 207, and after the method 200 has been completed, the controller 110 may be in a waiting state waiting for a user input to start the method 200 again at the initialisation step 201.

In embodiments, the sixth step 206 further comprises decreasing the pressure in the storage volume of the beverage container from the first pressure to a second pressure. Furthermore, the sixth step 206 and the fifth step 205 may be performed at least partially simultaneously. Hence, during dispensing of the beverage, the pressure in the storage volume may be decreased.

The decreasing of the pressure in the storage volume of the beverage container may be substantially gradually, or may be in any number of steps. For example, the pressure may be decreased in two, three, four, or more steps, which steps may result in substantially the same pressure drop.

FIG. 3 schematically depicts another embodiment of a beverage dispensing assembly 100, which in this embodiment is a cider dispensing assembly 100. The dispensing assembly 100 comprises the cider cooler 106 and is provided with the cider keg 104 and the carbon dioxide cartridge 108. The person skilled in the art will appreciate that the embodiments of the beverage dispensing assemblies discussed herein may also be used for dispensing of beverages other than cider.

As an option, the dispensing assembly 100 of FIG. 3 comprises a compressor 208 for providing a pressurised gas to the cider keg 104 for pressurising the cider. The compressor 208 may be arranged for compressing a gas, such as air or carbon dioxide. As such, with the compressor 208, a higher pressure may be achieved than the pressure of the carbon dioxide in the carbon dioxide cartridge 108. As a further option, the controller 110 may be arranged to control the compressor 208.

In the particular embodiment of FIG. 3, the pressurisation unit 301 comprises a sealable pressure chamber 302 arranged to receive the beverage container 112 therein. The sealable pressure chamber 302 comprises a gas passage for receiving a pressurised gas and a beverage passage for receiving a beverage. As an option, the gas drain valve 118 is connected to the sealable pressure chamber 302 such that the gas drain valve 118 can be used to drain gas from the sealable pressure chamber 302. Also in this embodiment, the beverage container 112 may be cooled by means of a container cooler unit 113 as depicted by and discussed in conjunction with FIG. 1.

When the sealable pressure chamber 302 is pressurised with the beverage container 112 therein, the storage volume of the beverage container 112 also becomes pressurised. Contrary to the embodiment of FIG. 1, here, the pressure inside the storage volume is equal to the pressure on the beverage container 112. Hence, a container wall of the beverage container 112 is not subjected to pressure forces which may cause damage to the beverage container 112 when the sealable pressure chamber 302 is used.

The sealable pressure chamber 302 may comprise a door for selectively opening and closing off an access opening into the sealable pressure chamber 302. In an open state, a user can place the beverage container 112 into the sealable pressure chamber 302, and in the closed state, a substantially gas tight pressure chamber 302 is obtained. As an option, a sensor may be present which may provide a sensor signal to the controller 110 indicative of whether the sealable pressure chamber 302 is in the closed state. As a further option, a locking mechanism may be present to lock the sealable pressure chamber 302 in the closed state, which locking mechanism may be operable by the controller 110.

As an even further option which may also be used in conjunction with other embodiments, the beverage dispensing assembly comprises a sensor unit 306 for determining dispensing data, wherein the controller 110 is arranged for receiving the dispensing data and controlling at least the pressurisation unit 301 based on the dispensing data. For example, the dispensing data may comprise data indicative of a volume of beverage present in the storage volume of the beverage container. Hence, the dispensing data may be indicative of an empty or filled storage volume, and/or the dispensing data may be indicative of a particular volume of beverage inside the storage volume.

The dispensing data may further be indicative of a pressure inside the sealable pressure chamber 302 or in another pressure chamber for other embodiments of the beverage dispensing assembly 100.

As an option which may also be comprised by other embodiments of the beverage dispensing assembly 100, the embodiment of the beverage dispensing assembly 100 comprises a beverage sampling unit 304 for sampling the beverage before dispensing. In particular, the beverage sampling unit 304 may be arranged to obtain beverage data indicative of at least one of alcohol content, sugar content, and dissolved gas content.

The beverage sampling unit 304 may be used to continuously sample the beverage, or may be used to sample a number of times or one time when a new keg 104 is provided to the beverage dispensing assembly 100. In particular with beverages such as cider, at least one of alcohol content, sugar content, and dissolved gas content may differ per batch.

The beverage sampling unit 304 may be arranged to generate a sampling signal indicative of the beverage data and to send this sampling signal to the controller 110. The controller 110 may in turn be arranged for receiving the signal, and for controlling at least one of the cider cooler 106 and the pressurisation unit 301 based on at least part of the sampling signal. For example, a higher alcohol content indicated in the sampling signal may be used by the controller 110 to decrease the first temperature to which the cooling unit 106 cools the beverage.

Although not depicted in the figures, embodiments of the beverage dispensing assembly may comprise one or more temperature sensors for determining a temperature of the beverage before, during and/or after dispensing.

Furthermore, embodiments of the beverage dispensing assembly may comprise one or more pressure sensors for determining a pressure inside the storage volume of the beverage container and/or a pressure on the beverage before, during and/or after dispensing.

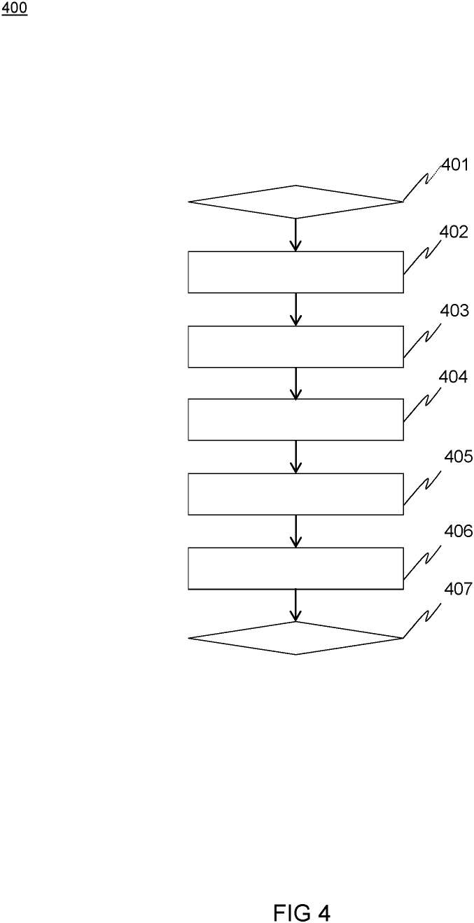

FIG. 4 schematically depicts another embodiment of a method of dispensing a supercooled beverage, for example using the embodiment of the beverage dispensing assembly 100 as shown in FIG. 3.

The method 400 starts in an initialisation step 401. During this step, for example, a user may open the sealable pressure chamber 302, place a beverage container 112 inside the sealable pressure chamber 302, and close the sealable pressure chamber 302. A sensor may indicate to the controller 110 that at least one of a beverage container 112 is placed inside the sealable pressure chamber 302 and that the sealable pressure chamber 302, which may cause the controller 110 to proceed with executing the method 400.

In a second step 402, the beverage is cooled to the first temperature below the melting point of the beverage. Optionally, the step of cooling the beverage may be performed continuously to allow substantially instant use of the dispensing assembly 100. A sensor may indicate to the controller 110 that the beverage has reached the first temperature, and is hence ready to be dispensed.

In a third step 403, the sealable pressure chamber 302 is pressurised up to a first pressure. This first pressure is higher than the ambient pressure. Prior to or during this increase in pressure, as an optional sub-step, at least part of the sealable pressure chamber 302 may be flushed with carbon dioxide to remove at least part of the air inside the pressure chamber 302. In particular, this may decrease the amount of oxygen inside the pressure chamber 302, which oxygen may negatively impact the quality of the dispensed beverage.

After the first pressure is reached in the sealable pressure chamber 302, which may for example be determined using the sensor unit 306, in a fourth step 404, beverage is dispensed into the pressurised storage volume of the beverage container 112. To this end, beverage may pass through the beverage passage of the sealable pressure chamber 302. The beverage can flow into the sealable pressure chamber 302 when the pressure on the beverage is at least equal to or higher than the first pressure.

In an optional fifth step 405, which may take place during the fourth step 404 of dispensing, the pressure inside the sealable pressure chamber 302, and thus also in the storage volume of the beverage container, is decreased from the first pressure to a second pressure.

Finally, for example when using the sensor unit 306 it is determined that the storage volume is sufficiently filled with beverage, dispensing is stopped in a sixth step 406 and the pressure inside the sealable pressure chamber 302 is released. When a locking mechanism is present, after decreasing the pressure inside the sealable pressure chamber 302, the locking mechanism may be released as well. The method 400 ends in a terminator 407.

It will be understood that throughout any of the steps of the embodiments of the method 200, 400 the sensor unit 306 may be used for determining dispensing data, which dispensing data may be used by the controller 110 for controlling the dispensing process.

1. A method of dispensing a beverage, comprising:
receiving a beverage container with a storage volume for receiving the beverage;
pressurising the storage volume of the beverage container up to a first pressure;
dispensing the beverage into the pressurised storage volume of the beverage container; and
decreasing the pressure in the storage volume of the beverage container to ambient pressure,
wherein the beverage is cooled to a first temperature below a melting point of the beverage prior to decreasing the pressure in the storage volume of the beverage container to ambient pressure.

2. The method according to claim 1, wherein the beverage is dispensed into the pressurised storage volume at the first temperature.

3. The method according to claims 1, wherein the beverage is cooled to the first temperature after being dispensed into the pressurised storage volume of the beverage container.

4. The method according to claims 1, wherein dispensing the beverage comprises providing the beverage at a third pressure.

5. The method according to claim 4, wherein the third pressure is substantially equal to the first pressure.

6. The method according to claim 1, further comprising, while dispensing the beverage, decreasing the pressure in the storage volume of the beverage container from the first pressure to a second pressure.

7. The method according to claim 6, wherein the change from the first pressure to the second pressure is substantially stepwise.

8. The method according to claim 1, wherein the beverage has an alcohol by volume content of 0.5% or more, preferably 2% or more.

9. The method according to claim 1, wherein the beverage comprises a dissolved gas, in particular carbon dioxide.

10. The method according to claim 1, wherein the beverage has a sugar content of 2 grams per litre or more, preferably 5 grams per litre or more, even more preferably between 8 and 12 grams per litre.

11. The method according to claim 1, further comprising sampling the beverage before dispensing the beverage for obtaining beverage data indicative of at least one of:
alcohol content;
sugar content; and
dissolved gas content.

12. The method according to claim 11, further comprising, while dispensing the beverage, decreasing the pressure in the storage volume of the beverage container from the first pressure to a second pressure, and, based on the obtained beverage data, controlling at least one of:
the first temperature;
- the first pressure;
- the second pressure; and
- when to decrease the pressure in the storage volume from the first pressure to the second pressure.

13. The method according to claim 1, wherein the dispensed beverage comprises solidified beverage at least after the pressure in the storage volume is decreased to the ambient pressure.

14. The method according to claim 1, further comprising cooling the beverage container to a temperature below ambient temperature.

15. A beverage dispensing assembly for dispensing a beverage, comprising: a cooling unit for cooling a beverage to a first temperature below the melting point of the beverage;
a pressurisation unit for pressurizing a storage volume of a beverage container;
a dispensing unit for dispensing the beverage into the storage volume of the beverage container; and
a pressure control unit for controlling a pressure in the storage volume and arranged to decrease the pressure in the storage volume.

16. The beverage dispensing assembly according to claim 15, wherein the pressurisation unit comprises a sealable pressure chamber arranged to receive the beverage container therein.

17. The beverage dispensing assembly according to claim 15, wherein the pressurisation unit comprises a sealing mechanism for sealing of the storage volume of the beverage container, and wherein the sealing mechanism comprises a gas passage for allowing passage of a pressurised gas into the storage volume, wherein, for example, the sealing mechanism further comprises a beverage passage for allowing passage of the beverage into the storage volume.

18. (canceled)

19. The beverage dispensing assembly according to claim 15, further comprising a sampling unit for sampling the beverage before dispensing for obtaining beverage data indicative of at least one of:
alcohol content;
sugar content; and
dissolved gas content.

20. The beverage dispensing assembly according to claim 15, further comprising a controller for controlling the pressure control unit and the pressurisation unit, and a sensor unit for determining dispensing data, wherein the controller is arranged for receiving the dispensing data and controlling the pressurisation unit based on the dispensing data.

21. The beverage dispensing assembly according to claim 20, wherein the dispensing data comprises data indicative of a volume of beverage present in the storage volume of the beverage container.
